(19) United States
(12) Patent Application Publication
(10) Pub. No.: US 2022/0232853 A1
(43) Pub. Date: Jul. 28, 2022

(54) SIMULATED SHELLFISH PRODUCT OF IMPROVED TEXTURE

(71) Applicant: NEW WAVE FOODS, San Francisco, CA (US)

(72) Inventors: Michelle WOLF, San Francisco, CA (US); Joseph ACKILLI, Stamford, CT (US); Tyre LANIER, Stamford, CT (US)

(21) Appl. No.: 17/611,998

(22) PCT Filed: May 15, 2020
(86) PCT No.: PCT/US20/33222

§ 371 Date: Nov. 17, 2021

Related U.S. Application Data
(60) Provisional application No. 62/849,484, filed on May 17, 2019.

(51) Int. Cl. A23J 3/22; A23J 3/16; A23J 3/14; A23L 29/256; A23L 29/212; A23L 5/20; A23L 29/00; A23L 29/30; A23L 5/43

(52) U.S. Cl. CPC A23J 3/225; A23J 3/16; A23J 3/14; A23L 29/256; A23L 29/212; A23V 2002/00; A23L 29/035; A23L 29/30; A23L 29/015; A23L 5/43; A23L 5/273

(57) ABSTRACT

Disclosed herein is a shellfish analogue product which simulates the natural texture of real shellfish meat

This application claims the priority benefit of U.S. Provisional Patent Application Ser. No. 62/849,484, filed May 17, 2019, which is hereby incorporated by reference in its entirety.

### FIELD OF THE INVENTION

The invention relates to simulated shellfish products possessing improved texture similar to the firmness and mouthfeel of genuine shellfish products.

### BACKGROUND OF THE INVENTION

Consumers have a keen interest in plant-based alternatives to shellfish, provided that such shellfish alternatives are a one-for-one swap for conventional shellfish in terms of their taste, texture, flavor, and performance compared to wild-caught or farmed shellfish. Traditional shellfish, such as shrimp, is also ecologically destructive to cultivate and is associated with a high bycatch ratio when harvested. A high-quality shellfish analogue has the potential to reduce consumption of traditionally sourced shellfish while meeting emerging consumer preferences.

Shifts in consumer habits toward consumption of plant-based analogues have precedent in the dairy and beef industries where there has been a material reduction in purchase of animal-based products and an increase in purchase of their plant-based analogues. This is primarily the case when the plant-based alternatives have a comparable quality to their animal derived counterparts. However, shellfish-substitute products available commercially are limited in their ability to mimic the taste, texture, and performance of wild-caught or farmed shellfish.

The prior art contains examples of shellfish analogue products, seafood analogue products, and meat analogue products which are produced by combining protein with alginate and reacting the combination with calcium salts in the presence of heat to produce a gelled product which is formed into the shape of shrimp or meat in one instance by utilizing a mold. The finished products are typically frozen. When they are thawed, the prior art patentees have asserted that the shrimp analogue product had the desired texture and chewiness of natural shrimp. Examples include those described in U.S. Pat. No. 4,554,166 to Morimoto; U.S. Pat. No. 4,396,634 to Shenouda et al.; and U.S. Patent Application Publication No. 2003/0211228 to Ballard.

U.S. Pat. No. 4,994,366 to Wu et al. discloses a process for forming a simulated crustacean product which includes using a mixture of surimi paste, preferably derived from Alaska Pollack; starch; protein; and konnyaku powder. In an attempt to improve the texture of shrimp analogue products one of the present inventors filed a patent application, U.S. Patent Application Publication No. 2018/0084815, describing an analogue product containing a hydrocolloid material, protein material, and an algal extract. However, these products fall short of the true texture and mouthfeel of natural shellfish.

To achieve material market penetration with an analogue product, there remains a need in the art to produce a shellfish analogue product which truly resembles the texture and mouthfeel of natural shrimp and shellfish products. This will fully capture consumer interest in alternatives. The invention disclosed herein overcomes deficiencies in the art.

### SUMMARY OF THE INVENTION

The present invention discloses an improved simulated shellfish analogue product possessing a texture similar to that of genuine shellfish products, particularly the firmness and mouthfeel of the genuine products. The technology is applicable to all crustacean or shellfish products.

In one embodiment, the shellfish analogue product which simulates the natural texture of real shellfish meat comprises alginate at a level of from 1.5% to 5% by weight of the shrimp analogue product; a sequestrant at a level sufficient to chelate any divalent ions present in water prior to alginate reaction with calcium ions; starch at a level of from 2% to 6% by weight of the analogue product; protein at a level of from 3% to 12% by weight of the analogue product; a calcium salt at a level of from 2% to 5% by weight of the analogue product; konnyaku, liquid filled calcium-alginate beads, or a combination of konnyaku and liquid filled calcium-alginate beads; and water at a level of from 60% to 75% by weight of the analogue product.

In one embodiment, the shellfish analogue product is a shrimp analogue product.

As described herein, all percentages are based upon composition by weight of the analogue product unless specifically addressed otherwise.

### DETAILED DESCRIPTION

The present invention is directed to an improved shellfish analogue product. The shellfish analogue product comprises ingredients in the ranges described herein (by weight of the product), and has texture (and other organoleptic properties) similar to the firmness and mouthfeel of genuine shellfish products.

In one embodiment, the shellfish analogue product comprises alginate at a level of from 1.5% to 5% by weight of the shrimp analogue product; a sequestrant at a level sufficient to chelate any divalent ions present in water prior to alginate reaction with calcium ions; starch at a level of from 2% to 6% by weight of the analogue product; protein at a level of from 3% to 12% by weight of the analogue product; a calcium salt at a level of from 2% to 5% by weight of the analogue product; konnyaku, liquid filled calcium-alginate beads, or a combination of konnyaku and liquid filled calcium-alginate beads; and water at a level of from 60% to 75% by weight of the analogue product.

Shellfish products include, without limitation, shrimp, lobster, and crab.

In one embodiment, the shellfish analogue product is a shrimp analogue product.

In one embodiment, konnyaku is present in the analogue product in a solid form having the shape of a cylinder or grain-like particle. In one embodiment, the size of the konnyaku particles are in the range of from 0.5 mm to 8 mm in length and 0.5 mm to 4 mm in diameter. The konnyaku may be incorporated into the shellfish analogue product at a level of from 10% to 25% by weight of the shellfish analogue product.

Konnyaku is a firm, alkalized gel of konjac powder, solubilized in water, and reacted with a salt such as calcium hydroxide. Konjac powder comes from the corm of the konjac plant also known as konjaku, konnyaku potato, devil's tongue, or elephant yam. The konnyaku particles are composed of approximately 97% water with the remaining 3% being mostly fiber in the form of a viscous substance called glucomannan plus some traces of protein, starch, and minerals like calcium.

Konjac powder or glucomannan fiber, in an unreacted state, will not be effective in producing a sinewy texture and texturally diverse mouthfeel which is essential to replicating a shellfish-like texture in the present invention. Other names for Konjac powder include Konjac flour and Konnyaku powder.

In one embodiment, konnyaku is present in the shellfish analogue product alone without liquid filled calcium-alginate spheres or beads.

In another embodiment, konnyaku is present in the shellfish analogue product, along with liquid filled calcium-alginate spheres or beads.

In a further embodiment, liquid filled calcium alginate spheres or beads are present in the shellfish analogue product alone without any konnyaku.

The konnyaku and/or liquid filled calcium-alginate spheres or beads function as inclusions which change the texture of the analogue product as described hereinafter.

In one embodiment, if the shellfish analogue product contains liquid filled calcium-alginate spheres or beads, they would be added at a level of from 5% to 15% by weight, or at a level of from 8% to 12% by weight.

In one embodiment, the liquid filled calcium-alginate spheres or beads are made by a process where alginate gel is dropped into a calcium solution to produce a circular product containing liquid centers resembling the texture of caviar. In one embodiment, the liquid filled calcium-alginate beads range in size of from about 0.5 mm to about 6 mm in diameter. Additional information concerning the manufacture of liquid filled calcium-alginate spheres can be found in www.molecularrecipes.com/spherification-class/7-tips-making-spherification-caviar/, which is herein incorporated by reference.

The shellfish analogue product disclosed herein incorporates alginate which is, according to one embodiment, sodium alginate. In another embodiment, the alginate is potassium alginate.

The sequestrant is, according to one embodiment, selected from the group consisting of sodium citrate, tetrasodium pyrophosphate, sodium hexametaphosphate, trisodium phosphate, sodium tripolyphosphate, sodium carbonate, and combinations thereof.

The sequestrant may be incorporated into the shellfish analogue product in an amount of from 0.10% to 0.50% by weight of the analogue product. In one embodiment, the sequestrant is sodium citrate. The sequestrant functions to chelate any divalent ions present in water prior to the reaction between the alginate and calcium.

The starch which is incorporated into the shellfish analogue product is used to supply a freeze-thaw stability to the shellfish analogue product by retaining free water within the gel matrix. The starch can be either native starch, or physically or chemically modified starch such as pregelatinized starch, acid thinned starch, cross-linked starch, stabilized starch, OSA starch, or starch with substitution to provide thermo irreversible gels, freeze-thaw stability, and process tolerance benefits.

In one embodiment, the starch is a physically modified starch. For example, such modification may be a heat and moisture treatment to provide process tolerance. In one embodiment, the modified starch is selected from the group consisting of tapioca starch, waxy tapioca starch, corn starch, waxy corn starch, high amylose corn starch, rice starch, waxy rice starch, potato starch, pea starch, sago starch, wheat starch, and combinations of thereof.

The calcium salt is, according to one embodiment, encapsulated such that the calcium cannot react with the alginate until the calcium-alginate solution reaches a temperature of from 120° F. to 150° F. and the calcium is released from the encapsulating material. In one embodiment, the calcium salt is encapsulated in a lipid or edible wax that is effective to prevent the interaction of calcium with its environment until it is heated to the aforementioned temperature range. In one embodiment, the encapsulated calcium salt is selected from the group consisting of calcium lactate, calcium chloride, calcium sulfate, monocalcium phosphate, and combinations thereof. In one particular embodiment, the calcium salt is encapsulated calcium lactate.

The shellfish analogue product incorporates a protein which may be selected from any of the following: soy protein isolate, soy protein concentrate, pea protein isolate, pea protein concentrate, rice protein isolate, rice protein concentrate, potato protein isolate, potato protein concentrate, chickpea protein isolate, chickpea protein concentrate, algal protein isolate, algal protein concentrate, mung bean protein isolate, mung bean protein concentrate, lentil protein, faba bean protein, navy bean protein, texturized vegetable proteins (TVP), and combinations of thereof. In one particular embodiment, the protein is soy protein isolate.

The shellfish analogue product disclosed herein may also contain a hydrocolloid. Suitable hydrocolloids include, but are not limited to, konjac gum, carrageenan, locust bean gum, gellan gum, pectin, xanthan gum, guar gum, gum arabic, and combinations of thereof. Gum may be combined synergistically to emulsify, provide suspension, create mouthfeel, increase viscosity, and to generate unique gel characteristics similar to seafood analogues. When present, the hydrocolloid may be included at a level or amount of about 0.1 to 3% by weight of the shellfish analogue product.

In one embodiment, alginate, carrageenan, and locust bean are used to improve tenderness of product. Addition of low acyl gellan gum may be added to improve snap of the product. Gum acacia, as a binder, when added at 0.5 to 3%, may create a fibrous texture, increased chewiness, improved mouthfeel, and reduced toughness.

In one particular embodiment, the analogue product is a shrimp analogue product comprising sodium alginate at a level of from 2.5% to 3.5% by weight, a sequestrant at a level of from 0.10% to 0.20% by weight, a physically modified starch at a level of from 2% to 3% by weight, protein at a level of from 5% to 7% by weight, konnyaku particles at a level of from 12% to 15% by weight, and an encapsulated calcium salt at a level of from 2% to 3.5% by weight.

The shellfish analogue product disclosed herein may also contain optional ingredients such as sweeteners, salts, and flavorants.

If a sweetener is included in the shellfish analogue product, it is included at a level of from 1% to 4% by weight of the analogue product. In one embodiment, the sweetener is selected from any of the following: stevia, agave, honey, coconut sugar, cane sugar, cane juice, white granulated sugar, sugar derivatives, fruit sugars, high intensity sugar substitutes, and combinations thereof. However, other sweeteners are known and may also be used. In one embodiment, the sweetener is white granulated sugar.

If a salt is included in the analogue product, it may be selected from sodium chloride, potassium chloride, and combinations thereof and at a level of from 0.1% to 1% by weight of the analogue product. Other salts may also be used.

If a colorant is included in the analogue product, it may comprise a natural or artificial colorant. In one embodiment, the colorant comprises a color mimicking the color of natural shrimp. Natural colorants include, without limitation, lycopene, beta carotene, turmeric, beet, berry extracts, and combinations thereof. In one embodiment, when a colorant is included, it is included after the shellfish analogue product is released from a mold after heating, and prior to being cooled and frozen.

If a flavorant is added to the analogue product it may be a natural or artificial seafood flavor formulated to mimic the flavor of shrimp. Such natural seafood flavors, and their incorporation into shellfish analogue products are known in the art. In one embodiment, a flavorant is included in the shellfish analogue product at a level or amount of from about 0.06% to 0.1% by weight. In another embodiment, a flavorant is included in the shellfish analogue product at a level or amount of from about 2% to 3% by weight.

According to one embodiment, the shellfish analogue product is a vegan product in that it does not contain animal products or animal derived products.

The present invention relates to a unique combination of ingredients which, when properly combined and constructed into a finished product, more closely simulate the natural texture of real shellfish (e.g., shrimp) meat (i.e., a cellular product rather than a continuous gel). Natural shrimp is a complex structure composed of compacted muscle fibers, each of which is a biological cell. Muscle cells are comprised of a cell membrane which contains within it an aqueous milieu in which is suspended tiny organelles and proteins. These muscle cells can thus be envisioned as resembling elongated microscopic water balloons, where the cell membrane contains its liquid milieu much as the elastic balloon contains water under pressure. This pressure within a biological cell is a turgor pressure if the membrane (or elastic balloon) is broken, the liquid contained within bursts out with some force. In a freshly cooked shrimp tail, this natural turgor pressure of each cell is what imparts the characteristic firmness to the product. Upon mastication by the consumer, the rupture of the numerous cells imparts the characteristic ‘snap’, ‘crispiness’, and ‘fibrousness’ desired by most consumers. To date, simulated shrimp analogues made from either animal or plant proteins or hydrocolloids largely consist of a continuous gel, which does not impart the characteristics of non-homogeneous cellular rupture upon mastication.

The present inventors have manufactured a shellfish analogue product that imparts a mastication experience much closer to that of natural shrimp. This is achieved by a careful combination of varying types of inclusions-specifically, physically modified starch, konnyaku, and/or liquid filled calcium-alginate spheres or beads, some of which have demonstrable turgor pressure and some which do not (but nonetheless do exhibit a mastication experience similar to that of biological cells with turgor pressure), into a continuous gel matrix of the required properties needed to properly imbed all inclusions. For example, the physically modified starch, in addition to being effective to create a freeze thaw stability, also swells with heating to form microscopic beads that exhibit turgor pressure and help break up the continuity of the continuous gel matrix imparted by the alginate/protein/calcium gel matrix. In one embodiment, oil at an amount of about 1 to 5% by weight could be added to reduce rigidity of gel matrix by creating weak points in the gel structure. In those embodiments that incorporate konnyaku, the konnyaku particles, due to their quite tough texture (high strength and deformability), not only break up the continuity of the continuous gel matrix composition but also impart fibrous, muscle cell-like mastication properties. In those embodiments that incorporate liquid filled calcium-alginate spheres or beads, the tiny alginate spheres or beads are made up of an outer membrane of calcium-alginate with a liquid center. The combination of these are able to impart a turgor pressure.

The shellfish analogue product achieves many of the desirable organoleptic properties of natural shellfish. Several of such properties include, without limitation, hardness, springiness, gumminess, chewiness, adhesiveness, and cohesiveness. Adhesiveness is defined as the degree to which a sample sticks to surfaces. Hardness is defined as the force to attain a given deformation, usually the initial bite through sample with a probe. Resilience is defined as how well a product fights to regain its original shape and size. Springiness is a degree to which the sample recovers after force is removed. Cohesiveness is defined as the degree to which the sample deforms rather than crumbles and breaks. Gumminess is defined as the property of being cohesive and sticky. Gumminess is the multiplication of hardness and cohesion. Chewiness is defined as the sensation of labored chewing due to sustained, elastic resistance from the food. Chewiness is the multiplication of hardness, cohesiveness, and springiness. These properties can be tested, for example, using known compression and TPA tests.

In one embodiment, the shellfish analogue product of the present invention has a hardness comparable to that of real shrimp. Real shrimp has a hardness of about 525 g force. One embodiment of the shellfish analogue product of the present invention has a hardness of about 490 g, or about 450-750 g or any integer, fraction, or range therein, or about 460-740, or 470-730, 480-720, or 490-710 g, or about 450, 460, 470, 480, 490, 500, 510, 520, 530, 540, or 550 g.

In one embodiment, the shellfish analogue product of the present invention has a resilience comparable to that of real shrimp. Real shrimp has a resilience of about 35%. One embodiment of the shellfish analogue product of the present invention has a resilience of about 55%, or about 30-60% or any integer, fraction, or range therein, or about 35-55, or 40-50%, or about 30, 35, 40, 45, 50, 55, or 60%.

In one embodiment, the shellfish analogue product of the present invention has a cohesion comparable to that of real shrimp. Real shrimp has a cohesion of about 0.7%. One embodiment of the shellfish analogue product of the present invention has a cohesion of about 0.8% or about 0.6 to about 0.8% or any integer, fraction, or range therein, or about 0.65-0.75% or about 0.6, 0.65, 0.7, 0.75, or 0.8%.

In one embodiment, the shellfish analogue product of the present invention has a springiness comparable to that of real shrimp. Real shrimp has a springiness of about 65%. One embodiment of the shellfish analogue product of the present invention has a springiness of about 85%, or about 60-85% or any integer, fraction, or range therein, or about 65-80 or 70-75%, or about 60, 65, 70, 75, 80, or 85%.

In one embodiment, the shellfish analogue product of the present invention has a gumminess comparable to that of real shrimp. Real shrimp has a gumminess of about 350. One embodiment of the shellfish analogue product of the present invention has a gumminess of about 390, or about 350-450 or any integer, fraction, or range therein, or about 350-400, or 350-375, or about 350, 360, 370, 380, 390, or 400.

In one embodiment, the shellfish analogue product of the present invention has a chewiness comparable to that of real shrimp. Real shrimp has a chewiness of about 230. One embodiment of the shellfish analogue product of the present invention has a chewiness of about 310-315, or about 250-350 or any integer, fraction, or range therein, or about 260-340, 270-330, 280-320, or 290-310, or about 250, 260, 270, 280, 290, 300, 310, 320, 330, 340, or 350.

In one embodiment, the shellfish analogue product has any one or more of the above properties of hardness, resilience, cohesion, springiness, gumminess, or chewiness described above.

Shellfish analogue products of the present invention may be prepared as follows.

To begin, a calcium-alginate gel is formed, as follows. Deionized water is added to an alginate, a sequestrant, starch, and protein (and, optionally, sugar and salt). The sequestrant acts to chelate any divalent ions that might have been in the mixture prior to the alginate-calcium reaction, which may occur later in the process in the presence of heat. The ingredients are then mixed together using, e.g., mechanical agitation. Mixing of the ingredients may be carried out for a minute or for several minutes, depending on conditions and batch size. If desired, flavorants may then be added to the mixture. Further mixing using, e.g., mechanical agitation may be required.

In one embodiment, formation of the calcium alginate gel is a highly controlled reaction. According to this embodiment, careful monitoring during the mixing process is useful to detect any signs of gel formation or excessive air incorporation. Gel formation at this stage may be indicative of a process error.

Konnyaku, encapsulated calcium lactate salt, and/or liquid filled calcium-alginate beads may be added to the mixture and mixed under low shear for one to several minutes, until all ingredients are well dispersed to achieve a homogenous mixture with good dispersion of encapsulated calcium lactate salt.

The mixture may then be kept at room temperature so as to not accelerate the formation of the calcium-alginate gel.

The mixture at this point in the process may be paste-like. The paste can then be deposited into molds shaped as desired (e.g., shaped like natural shrimp). The paste may then be heated in the molds until the paste reaches a temperature of 185° F. to 210° F.

The analogue product may then be released from their molds after heating and then then cooled (e.g., and without limitation, at 40° F.) for a period of time (e.g., and without limitation, 2 hours) and then placed into a freezer until they reached 0° F. to achieve the correct final texture.

Thus, in another aspect, the invention is directed to a method of making a shellfish analogue product of the present invention. This method involves mixing an alginate; a sequestrant; starch; protein; a calcium salt; konnyaku, liquid filled calcium-alginate beads, or a combination of konnyaku and liquid filled calcium-alginate beads; and water. The mixture may then be formed or molded to a desire shape. In one embodiment, the mixture is then heated and then cooled. In one embodiment, the formed product is then chilled in a freezer to achieve a correct final texture to form a shellfish analogue product.

The invention is illustrated but not limited by the following examples.

### EXAMPLES

### Example 1

The ingredients in Table 1 were utilized to manufacture a vegan, shrimp analogue product. The product contained both konnyaku and liquid filled calcium-alginate spheres.

TABLE 1

| INGREDIENT | % IN FINAL PRODUCT |
|---|---|
| Sodium Alginate | 3.03 |
| Water | 60.17 |
| Sodium Citrate | 0.16 |
| Potato Starch | 2.37 |
| Soy Protein Isolate | 5.53 |
| Liquid filled calcium-alginate spheres | 9.87 |
| Konnyaku | 13.42 |
| Encapsulated Calcium Lactate | 2.61 |
| Flavor | 0.08 |
| Sugar | 2.37 |
| Salt | 0.39 |
| Total | 100.00 |

Liquid filled calcium alginate spheres were made by a process where unreacted alginate gel was dropped into a calcium solution bath with a syringe in small droplets to produce a circular product containing liquid centers.

To begin the process of forming the calcium-alginate gel, deionized water was added to the sodium alginate, sodium citrate, potato starch, soy protein isolate, sugar, and salt. The sodium citrate acted as a sequestrant to chelate any divalent ions that might have been in the mixture prior to the alginate-calcium reaction, which occurred later in the process in the presence of heat. The ingredients were mixed together for approximately 2 minutes under strong mechanical agitation. Then the flavor was added to the mixture and the mixture was further combined under strong mechanical agitation for another 3 minutes. The formation of the calcium alginate gel is a highly controlled reaction, so it was carefully monitored during the mixing process for any signs of gel formation or excessive air incorporation. Gel formation at this stage is indicative of a process error.

The konnyaku, encapsulated calcium lactate salt, and liquid filled calcium-alginate beads were then added to the mixture and mixed under low shear for 1 to 2 minutes until all ingredients were well dispersed. The mixture was homogenous with excellent dispersion of the encapsulated calcium lactate salt. The mixture was kept at room temperature so as to not accelerate the formation of the calcium-alginate gel.

The mixture at this point in the process was paste-like. The paste was deposited into molds shaped like natural shrimp. The paste was then heated in the molds until the paste reached a temperature of 195° F.

The shrimp analogue products were released from the molds after heating. The shrimp analogue products were then cooled at 40° F. for 2 hours and then the shrimp analogue products were placed into a freezer until they reached 0° F. The analogue product underwent the freezing step before serving to achieve the correct final texture.

An internal trained panel tasted the product and compared it to samples of traditional shrimp. The panel summarized their feedback: “Sample 1 (Example 1) had a first bite that crunched in the same way as the samples of traditional shrimp. Upon further mastication, the shrimp's texture had a fibrous, muscle-like texture that is characteristic of eating a shrimp. The breakdown in the mouth was comparable to how shrimp break down. The flavor was subtle and clean but distinct. It had all the components of shrimp flavor: lightly sweet and savory with briny undertones.”

A trained chef provided the following feedback on the preparation and handling of the shrimp in various recipes: “The samples behaved almost identically to how a pre-frozen shrimp behaves in various recipes. It can be cooked in all the ways shrimp can: sautéed, grilled, boiled, baked, and even pureed into a mouse for shumai fillings.

### Example 2

The ingredients in Table 2 were utilized to manufacture a vegan, shrimp analogue product. This example and shrimp analogue which was produced differs from Example 1 in that liquid filled calcium-alginate spheres were not incorporated into the mixture.

TABLE 2

| INGREDIENT | % IN FINAL PRODUCT |
|---|---|
| Sodium Alginate | 3.17 |
| Water | 63.50 |
| Sodium Citrate | 0.17 |
| Potato Starch | 2.50 |
| Soy Protein Isolate | 5.83 |
| Konnyaku | 18.83 |
| Encapsulated Calcium Lactate | 3.00 |
| Flavor | 0.08 |
| Sugar | 2.50 |
| Salt | 0.42 |
| Color | 0.001 |
| Total | 100.00 |

The shrimp analogue product manufactured in this Example was tasted by the same trained taste panel. The trained panel summarized their feedback: “The sample was very similar to the first sample (Example 1). One of the key differences was that the bite of this sample had a more enhanced ‘pop.’ The fibrous texture of the product was maintained. These samples were slightly firmer during mastication than the first sample. The flavor was comparable to the first sample. Overall, this sample was comparable to the traditional shrimp samples that were tasted.”

The chef communicated the same feedback about the preparation of Example 1 for Example 2.

### Example 3

Another shrimp analogue product was manufactured from the ingredients listed in Table 3. This shrimp analogue product did not incorporate liquid filled calcium-alginate spheres.

TABLE 3

| INGREDIENT | % IN FINAL PRODUCT |
|---|---|
| Sodium Alginate | 3.07 |
| Water | 61.45 |
| Sodium Citrate | 0.16 |
| Potato Starch | 2.42 |
| Soy Protein Isolate | 6.77 |
| Konnyaku | 19.35 |
| Encapsulated Calcium Lactate | 3.87 |
| Flavor | 0.09 |
| Sugar | 2.42 |
| Salt | 0.41 |
| Total | 100.00 |

The manufacturing process was identical to the process described in Example 2.

The shrimp analogue product was tasted by the same trained taste panel and summarized as follows: “Sample 3 (Example 3) was similar in texture to Sample 1. The fibrous nature of the product was increased but the overall texture was softer compare to that of the Sample 1. The flavor was similar to Sample 1 and Sample 2.”

The chef communicated the same feedback about the preparation of Example 1 and Example 2 for Example 3.

### Example 4

Another shrimp analogue product was manufactured from the ingredients listed in Table 4. This example and the shrimp analogue produced differed from the previous examples in that konnyaku was not incorporated into the mixture.

TABLE 4

| INGREDIENT | % IN FINAL PRODUCT |
|---|---|
| Sodium Alginate | 3.54 |
| Water | 70.95 |
| Sodium Citrate | 0.19 |
| Potato Starch | 2.79 |
| Soy Protein Isolate | 6.52 |
| Liquid filled calcium-alginate spheres | 9.31 |
| Encapsulated Calcium Lactate | 3.35 |
| Flavor | 0.09 |
| Sugar | 2.79 |
| Salt | 0.47 |
| Total | 100.00 |

The shrimp analogue product was tasted by the same trained taste panel and summarized as follows: “Sample 4 (Example 4) was similar in texture to Sample 1 but the overall bite and mouth feel was softer. The fibrousness of this product was also markedly less than Sample 1. This sample is best suited for those who prefer a softer, more delicate texture. The flavor was similar to Sample 1 and Sample 2.”

The Chef communicated feedback that the handling of this product was similar to the previous samples and noted that this sample felt a bit softer as he was preparing it.

### Example 5

Another shrimp analogue product was manufactured from the ingredients listed in Table 5. This shrimp analogue product did not incorporate liquefied filled calcium-alginate spheres and contained a higher flavor impact.

TABLE 5

| INGREDIENT | % IN FINAL PRODUCT |
|---|---|
| Water | 64.69 |
| Lecithin | 0.15 |
| sunflower Oil | 2.42 |
| Flavors | 2.00 |
| Potassium Citrate | 0.17 |
| Potassium Alginate | 3.04 |
| Mung Bean Protein | 5.73 |
| Potato Starch | 2.42 |
| salt | 0.56 |
| sugar | 1.21 |
| Konnyaku | 15.00 |
| Encapsulated Calcium Lactate | 2.62 |
| Total | 100.00 |

The shrimp analogue product was tasted by the same taste panel and summarized as follows: “Sample 5 (Example 5) was similar in texture as Sample 3 (Example 3) but had a higher flavor impact.

The Chef communicated feedback that a higher flavor impact was observed.

### Example 6

The texture profile of one embodiment of the shellfish analogue of the present invention was measured using TA.XT.plus texture analyzer with Exponent software from Stable Micro Systems. Compression test using TA-23 probe was used to analyze hardness, springiness, gumminess, chewiness, resilience, and cohesiveness of the shellfish analogue samples, at the settings shown in Table 6.

TABLE 6
T.A. Settings: TPA Test

| Caption | Value | Units |
|---|---|---|
| Pre-Test Speed | 1.0 | mm/sec |
| Test Speed | 1.0 | mm/sec |
| Post-Test Speed | 1.0 | mm/sec |
| Target Mode | Distance | |
| Distance | 5.0 | mm |
| Time | 5.0 | Sec |
| Trigger Type | Auto (Force) | |
| Trigger Force | 5 | g |

| | |
|---|---|
| Break Mode | Off |
| Tare Mode | Auto |
| Advance Options | On |
| Control Oven | Disabled |
| Frame Deflection Correction | Off (XT2 compatibility) |

A sample of shrimp analogue product from Example 5 was tested for hardness, resilience, cohesion, springiness, gumminess, and chewiness. The results are illustrated in Table 7 and compared to real shrimp.

TABLE 7
Shellfish (Shrimp) Analogue Profile Comparison

| | Hard- | | | Springi- | | |
|---|---|---|---|---|---|---|
| | ness | Resilience | Cohesion | ness | Gummi- | Chewi- |
| | (g) | (%) | (%) | (%) | ness | ness |
| Real Shrimp | 523.0 | 36.3 | 0.7 | 66.0 | 350.9 | 231.0 |
| Shrimp | 490.7 | 55.0 | 0.8 | 84.9 | 389.2 | 312.6 |
| Analogue | | | | | | |
| (Example 5) | | | | | | |

The measurements of Table 7 correlated very well with sensory evaluation done by trained panelists confirming that the shrimp analogue had textural attributes and eating experience similar to real shrimp.

The foregoing is not to be limited in scope by the specific embodiments described herein. Indeed, various modifications and methods provided herein and their equivalents, in addition to those described herein will become apparent to those skilled in the art from the foregoing description. Such modifications are intended to fall within the scope of the appended claims.

1. A shellfish analogue product which simulates the natural texture of real shellfish meat which comprises:
alginate at a level of from 1.5% to 5% by weight of the analogue product;
a sequestrant at a level sufficient to chelate any divalent ions present in water prior to alginate reaction with calcium ions;
starch at a level of from 2% to 6% by weight of the analogue product;
protein at a level of from 3% to 12% by weight of the analogue product;
a calcium salt at a level of from 2% to 5% by weight of the analogue product;
konnyaku, liquid filled calcium-alginate beads, or a combination of konnyaku and liquid filled calcium-alginate beads; and
water at a level of from 60% to 75% by weight of the analogue product.

2. The shellfish analogue product of claim 1, wherein the shellfish is shrimp, lobster, or crab.

3. The shellfish analogue product of claim 2, wherein the shellfish is shrimp.

4. The shellfish analogue product of claim 1, wherein the shellfish analogue product comprises konnyaku.

5. The shellfish analogue product of claim 4, wherein the konnyaku has the following dimensions: 0.5 mm to 8 mm in length and 0.5 mm to 4 mm in diameter.

6. The shellfish analogue product of claim 4, wherein the konnyaku is incorporated at a level of from 10% to 25% of the analogue product.

7. The shellfish analogue product of claim 1, wherein the shellfish analogue product comprises liquid filled calcium-alginate beads.

8. The shellfish analogue of claim 7, wherein the liquid filled calcium-alginate beads are incorporated at a level of from 5% to 15% of the analogue product.

9. The shellfish analogue product of claim 1, wherein the alginate is sodium alginate or potassium alginate.

10. The shellfish analogue product of claim 1, wherein the sequestrant is selected from the group consisting of sodium citrate, tetrasodium pyrophosphate, sodium hexametaphosphate, trisodium phosphate, sodium tripolyphosphate, sodium carbonate, and combinations thereof.

11. The shellfish analogue product of claim 10, wherein the sequestrant is sodium citrate at a level of from 0.10% to 0.50% by weight of the shellfish analogue product.

12. The shellfish analogue product of claim 1, wherein the starch is physically or chemically modified starch.

13. The shellfish analogue product of claim 12, wherein the starch is selected from the group consisting of tapioca starch, potato starch, sago starch, pea starch, wheat starch, waxy or high amylose starch, and combinations thereof.

14. The shellfish analogue product of claim 12, wherein the modified starch is potato starch.

15. The shellfish analogue product of claim 1, wherein the calcium salt is encapsulated such that the calcium does not react with the alginate in solution until it reaches a temperature of from 120° F. to 150° F.

16. The shellfish analogue product of claim 1, wherein the calcium salt is selected from the group consisting of calcium lactate, calcium chloride, calcium sulfate, monocalcium phosphate, and combinations thereof.

17. The shellfish analogue product of claim 15, wherein the calcium salt is encapsulated calcium lactate.

18. The shellfish analogue product of claim 1, wherein the protein is selected from the group consisting of soy protein isolate, soy protein concentrate, pea protein isolate, pea protein concentrate, rice protein isolate, rice protein concentrate, potato protein isolate, potato protein concentrate, chickpea protein isolate, chickpea protein concentrate, algal protein isolate, algal protein concentrate, mung bean protein isolate, mung bean protein concentrate, and combinations thereof.

19. The shellfish analogue product of claim 18, wherein the protein is soy protein isolate.

20. The shellfish analogue product of claim 1 further comprising:
a sweetener at a level of from 1% to 4% by weight of the shellfish analogue product.

21. The shellfish analogue product of claim 20, wherein the sweetener is selected from the group consisting of stevia, agave, honey, coconut sugar, cane juice, white granulated sugar, sugar derivatives, fruit sugars, high intensity sugar substitutes, and combinations thereof.

22. The shellfish analogue product of claim 20, wherein the sweetener is white granulated sugar.

23. The shellfish analogue product of claim 1 further comprising:
sodium chloride, potassium chloride, or a combination thereof at a level of from 0.1% to 1% by weight of the shellfish analogue product.

24. The shellfish analogue product of claim 1 further comprising:
a natural colorant mimicking the color of shrimp selected from the group consisting of lycopene, beta carotene, turmeric, beet, berry extracts, and combinations thereof.

25. The shellfish analogue product of claim 1, wherein the shellfish analogue product comprises a combination of konnyaku and liquid filled calcium-alginate beads.

26. The shellfish analogue product of claim 1 comprising:
alginate at a level of 2.5% to 3.5% by weight of the shellfish analogue product;
starch at a level of 2% to 3% by weight of the shellfish analogue product;
protein at a level of 5% to 7% by weight of the shellfish analogue product;
calcium salt at a level of 2% to 3.5% by weight of the shellfish analogue product; and
konnyaku at a level of 12% to 15% by weight of the shellfish analogue product.

27. The shellfish analogue product of claim 1 further comprising:
a hydrocolloid at a level of 0.1 to 3% by weight of the shellfish analogue product.
